(19) United States
(12) Patent Application Publication
(10) Pub. No.: US 2010/0139193 A1
(43) Pub. Date: Jun. 10, 2010

(54) NONMETALLIC ULTRA-LOW PERMEABILITY BUTYL TAPE FOR USE AS THE FINAL SEAL IN INSULATED GLASS UNITS

(76) Inventors: Michael J. Goldberg, Prince Frederick, MD (US); Brandon D. Tinianov, Santa Clara, CA (US)

Correspondence Address: HAYNES AND BOONE, LLP;IP Section, 2323 Victory Avenue, Suite 700, Dallas, TX, 75219, US

(21) Appl. No.: 12/633,649

(22) Filed: Dec. 8, 2009

Related U.S. Application Data
(60) Provisional application No. 61/121,150, filed on Dec. 9, 2008.

(51) Int. Cl. E06B 3/667; E04C 2/24; B32B 7/12; C09J 5/00

(52) U.S. Cl. 52/309.3; 52/786.13; 428/355 EN; 156/305

(57) ABSTRACT

The object of the invention is a high performance tape for use in insulated glass units (IGUs) that combines exceptionally low permeability to gases and vapors with extremely low thermal conductivity. Prior art includes low-permeability aluminum-backed tapes as well as low-conductivity polymer-backed tapes, but nothing currently available serves both of these needs with a single product.

### CROSS REFERENCE TO RELATED APPLICATIONS

This application relates and claims priority to U.S. Provisional Patent Application No. 61/121,150 filed Dec. 9, 2008, the disclosure of which is incorporated by reference, as if fully stated here, for all purposes. This application is related to U.S. patent application Ser. No. 12/328,746 filed Dec. 4, 2008, the disclosure of which is incorporated by reference, as if fully stated here.

### BACKGROUND

Forty years ago, single glazed windows with separate storm windows and screens were standard in homes and businesses. Their performance as thermal insulators was poor. An important development for such windows beginning around 1965 was a change to insulating glazing—two panes of glass sealed together at the perimeter enclosing an air space in between the panes. Typically, incorporation of additional panes will increase the u-value of the structure from u=1.0 for a single-pane window to u=0.5 or u=0.34 for a double laminate. The “u-value” describes the overall heat transfer coefficient of the system, its units in the international system are W/(m²K) and in the US system the units are BTU/(h° F. ft²) (1 BTU/(h° F. ft²)=5.666 W/(m²K)). Generally, the u-value indicates the ability of an object or assembly to transfer heat through the structure. The lower the u-value, the better the insulating properties of the structure.

One obstacle that needed to be overcome in the development of such insulating units was the integrity of the gas and moisture seal at the perimeter. Insulated products developed prior to 1965 did not maintain a consistent seal and were prone to premature product failure in the form of reduced thermal performance and moisture condensation (fogging) within the insulated unit (Residential Windows 3^{rd} Ed., Carmody, et al. 2007). Today, nearly 90% of all residential windows sold are insulating. The performance of today's windows can be attributed to a few key technologies.

MULTI-PANE DESIGN: As noted above, insulated windows have been in use for many decades in residential, commercial and industrial contexts. Examples of such structures may be found in U.S. Pat. Nos. 2,303,125, 2,925,633, 4,015,394, 4,171,601, 4,226,063, 5,653,073, 6,055,783, 6,662,523, and 7,270,859. While each of these patents relates to dual layered glazing structures which provide better insulation performance than single-pane windows, increasing energy costs as well as demand for a superior product have given rise to a need for windows of even higher thermal insulation ability. For this reason, designs with three or more glazing layers have been developed. Examples of such structures may be found in U.S. Pat. Nos. 4,807,419, 4,853,264, 5,007,217, 5,156,894, 5,544,465, and 5,983,593. Windows incorporating three or more panes can have performance values from u=0.33 to u=0.10 or less.

NOBLE GAS FILL: Another and more recent method which has been developed for increasing the thermal insulation performance of windows is the incorporation of a low heat transfer gas such as sulfur hexafluoride (as described in U.S. Pat. No. 4,369,084), argon (as described in U.S. Pat. Nos. 4,393,105 and 4,756,783), krypton (U.S. Pat. No. 4,756,783) or even xenon. These gas-filled laminated windows outperform their air filled counterparts by 20 percent or more. Gas filling of cavities between window panes is disclosed in U.S. Pat. Nos. 4,019,295 and 4,047,351. U.S. Pat. No. 4,459,789 describes a multi-pane, thermally insulating window containing bromotrifluoromethane gas within the between-pane spaces. U.S. Pat. No. 4,604,840 discloses a multi-pane glazing structure containing a dry gas such as nitrogen in its between-pane spaces. U.S. Pat. No. 4,815,245, discloses the use of noble gases to fill between-pane spaces. Today the use or argon and krypton as an interpane gas fill is a common method to improve the performance of a window assembly.

SEALANT: A third key technology in the development of robust thermally efficient windows is the insulated glass unit's (IGU' s) perimeter seal. It is important, in order to ensure that the gas remains in the space between the panes, meaning that the unit must properly sealed around its edges for the lifetime of the product. U.S. Pat. Nos. 3,791,910, 4,334,941, 4,433,016, and 4,710,411 each describe various means for sealing multi-pane window structures. With regard to current technology, units may be either single-sealed or double-sealed. In the former case, the seal consists of typically butyl sealant applied around the edge of the unit, while the latter has two different types of sealant (see FIG. 1 from “Energy-efficient windows—for how long? Gas concentration in sealed glazing units”). It is important to note that in traditional window assemblies, the spacer is constructed from a metal square tube and therefore it is completely impervious to gas and to water vapor. For that reason, the first (or only) seal is applied at the spacer/pane interface, and not across the back surface of the spacer.

A double-sealed unit is normally tighter and maintains greater seal integrity than a single-sealed one. Double-sealed glazing units have a first inner butyl rubber seal and a second outer seal of polysulphide, polyurethane or silicone. Research shows that the particular choice of outer sealant is very important in determining how gastight the unit is. The initial gas concentration in newly manufactured sealed glazing units must be 90% or higher. An international standard for gas-filled glazing units, prEN 1279-3, specifies that gas loss in aging tests shall not exceed 1% per year.

As reported by Olsson-Jonsson, there is some published research on the durability of gas-filled sealed glazing units to which one can refer to. The investigation includes double-sealed glazing units with three different types of outer sealant—polysulphide, polyurethane and silicone. The results show that the majority of the polysulphide sealed units had a gas loss of less than 1% per year, the rest had a gas loss of more than 1% but less than 2% per year. About half of the glazing units with an outer seal of polyurethane had a gas loss of less than 1% per year, while the other part had a gas loss of 1-10%. Units with a silicone seal had a gas loss of over 10%, except for one single unit that had a gas loss of less than 0.5% per year. The authors point out the importance of careful manufacturing when sealing the glazing units. (“Energy-efficient windows—for how long? Gas concentration in sealed glazing units”, Agneta Olsson-Jonsson, http://www.byv.kth.se/avd/byte/reykjavik/pdf/art_{—}155.pdf) Obviously, many if not all of the existing dual seal technologies struggle to meet the gas retention requirements of the product standard. This is unacceptable. What is required is a new method for sealing the perimeter of insulated window units that maintains the gas retention and low water vapor transfer while not conducting thermal energy across the structure.

### SUMMARY OF THE INVENTION

The invention addresses the above-noted deficiencies of the prior art and thus provides a high performance tape used for sealing insulated glass units which combines exceptionally low permeability to gases and vapors with extremely low thermal conductivity in a single design unmatched by current industry offerings.

The invention offers a final seal solution for insulated glass units which provides a redundant, ultra-low permeability barrier to assist in the retention of insulating gases within the window.

The invention achieves the above-described benefits in a manner which is not detrimental to the overall thermal insulative performance of the window.

### BRIEF DESCRIPTION OF THE FIGURES

FIG. 1 is a schematic perspective view representation of a multilayer tape assembly of the present invention.

FIG. 2 shows a process schematic for the fabrication of PVDC from Vinylidene chloride (VDC).

FIG. 3 is a schematic cross-sectional representation of a multilayer tape assembly of the present invention.

FIG. 4 is a schematic cross-sectional representation of a multipane glazing structure.

FIG. 5 is a schematic cross-sectional representation of a multipane glazing structure incorporating the multilayer tape assembly of the present invention.

FIG. 6 is a perspective view of a complete insulated glass unit with the multilayer tape assembly of the present invention partially installed around three of the four edges.

### DETAILED DESCRIPTION OF THE INVENTION

Present options for outermost window seals include low-permeability aluminum-backed tapes as well as low-conductivity polymer-backed tapes, but nothing currently available meets the performance of these single attribute products with a novel, combined performance system.

The need for a tape which offers these features (low-permeability and low thermal conductivity) is driven by a desire for higher performance windows than those which are currently available today. In this case, a high performance window is one that offers very low heat transfer from one side to the other. The present invention helps achieve this goal in two ways. The low permeability of the structure of this invention guarantees that the insulating gas within the insulated glass unit (IGU) is as well contained as possible, thereby limiting the amount of gas lost through the edges of the IGU and insuring that the insulating properties of the window are retained over time. The low thermal conductivity of the tape insures that as little heat as possible is transferred transversely across the tape from one side of the IGU to the other, thus eliminating the final seal tape as a primary path of heat transfer through the window.

Several manufacturers produce tapes suited for final sealing of IGUs which employ a polyisobutylene (PIB) based butyl rubber adhesive, laminated to an aluminum foil backing material. The PIB adhesive provides a strong bond to the glass and has reasonably low permeability to vapors and gases, while the aluminum foil backing material gives the tape its primary structure and its exceptionally low permeability to vapors and gases. While the aluminum material does provide inherently low permeability, its high thermal conductivity hinders the overall insulating performance of the window by providing a direct path for heat transfer across the IGU around its entire perimeter.

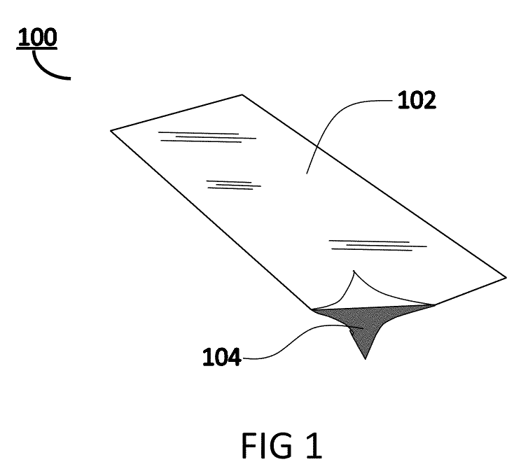

The proposed invention has one or more key differences from current commercially available tapes used for the final seal in IGUs. Rather than employing aluminum foil as the backing material typical of the current art, the proposed tape utilizes an ultra-low permeability laminated polymer film. As shown in FIG. 1, the tape assembly 100 consists of one or more layers of polyvinylidene chloride (PVDC) 102, laminated to a layer of butyl rubber adhesive 104. PVDC is the key ingredient in many ultra-low permeability films available from several different manufacturers, including Innovia Films of Cumbria, United Kingdom, the Dow Chemical Company of Midland, Mich., and Dupont Teijin Films of Hopewell, Va.

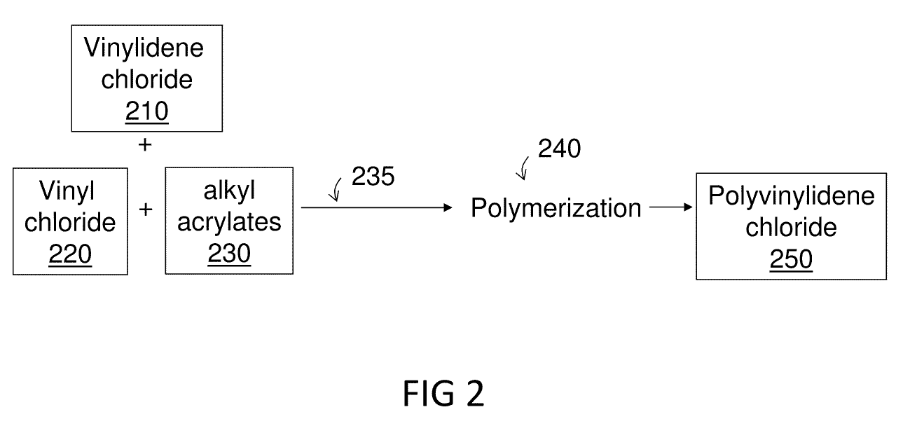

FIG. 2 shows a process schematic for the manufacturing of polyvinylidene chloride 250 (PVDC) for use in tape assembly 100, according to some embodiments of the present invention. The film is manufactured via Vinylidene chloride (VDC) polymerization, using a variety of methods and processes. PVDC-based polymers are produced by reacting VDC 210 with other comonomers like vinyl chloride 220 (VC) and alkyl acrylates 230 in closed systems under controlled conditions. An initiator 235 is added to start the polymerization 240. The location of comonomer units along the polymer chain depends on the quantity and reaction kinetics of the comonomer with VDC 210. The location and regularity of the comonomer units can affect the properties and performance of the copolymer.

The majority of PVDC is used in food packaging and PVDC is particularly effective for products with a high fat content and strong flavors and aromas. For this reason PVDC is often used for food such as confectionery, dehydrated foods, dairy products, sausages, pâtés, large cuts of meat, smoked fish and dried products such as herbs, spices, tea and coffee.

PVDC's outstanding barrier properties also make it suitable for use in medical applications where high levels of impermeability are demanded. For example PVDC is the mostly used barrier material for push-through blister packs for pills and in the manufacture of colostomy bags. The use of PVDC in architectural windows is believed novel.

FIG. 1 shows a perspective view of the novel tape assembly. The top or outer layer 102 consists of one or more layers of polyvinylidene chloride (PVDC) with a thickness between about 0.005 and 0.050 inches. The bottom or inner layer 104 consists of a polyisobutylene (PIB) based butyl rubber adhesive with a thickness between about 0.005 and 0.100 inches.

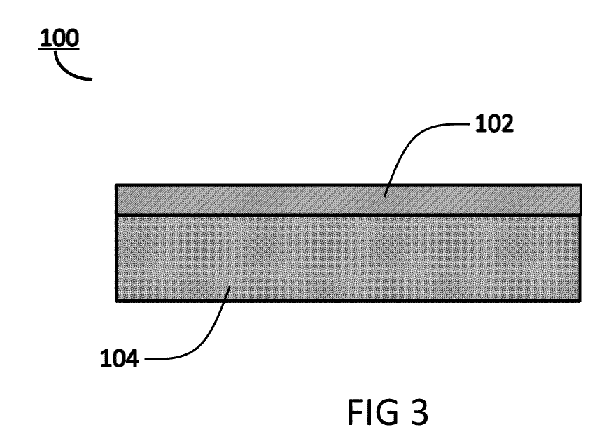

FIG. 3 shows a cross section view of tape assembly 100 according to the embodiment depicted in FIG. 1. Layers 102 and 104 are also shown.

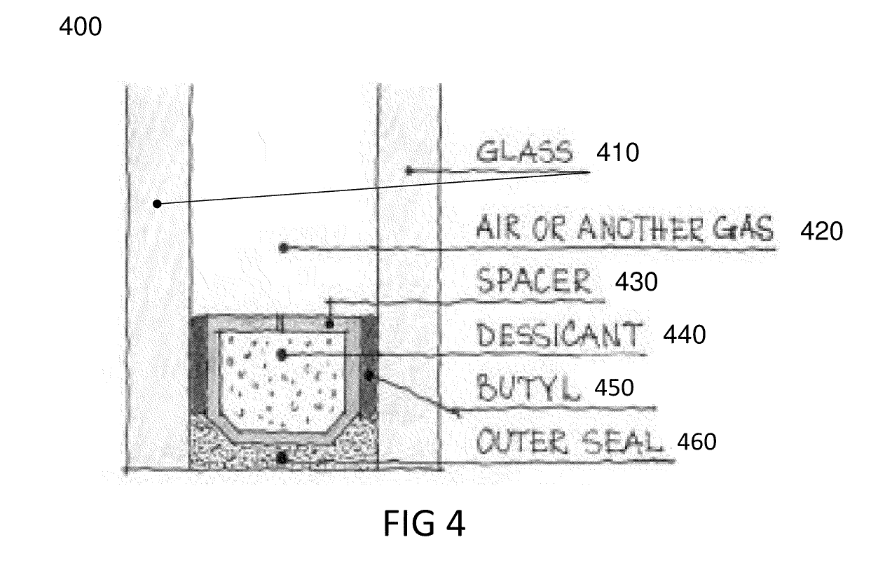

FIG. 4 shows the existing prior art for sealing an insulated glass unit. Shown in the figure is a cross sectional view of a common ‘double-sealed’ insulated glass unit 400. The double-sealed glazing unit 400 according to the embodiment shown in FIG. 4 includes two panes of glass 410, separated by spacer 430, with air or some other gas 420 filling the space between the glass panes. Double-sealed glazing units also include a first inner butyl rubber seal 450 applied between the spacer surface and the glass pane surface. Second, an outer seal of polysulphide, polyurethane or silicone 460 is applied so as to substantially or completely fill the void between the two opposing panes of glass and the unexposed or back surface of the spacer. The role of each seal in this configuration is very specific. The first seal 450 mates with the impervious metal seal to create a very low permeability junction. Because metal is intrinsically air and water vapor impervious, the butyl layer 450 is not required nor desired behind the spacer. Specifically, butyl is undesirable in this location because butyl provides an unsuitable mounting/adhesion surface for the second seal material. For the second seal 460, a polyurethane, silicon or other material is applied to ensure the structural integrity of the assembly. The second seal 460 acts as a durable bonding agent for an assembly that must maintain its mechanical integrity over a 20-50 year service life. Although the second seal is structurally sound, it does not provide an adequate barrier to the transmission of water vapor. It is therefore important to note that the selection of materials and their particular order of application play an important role in the performance of the final window assembly for long term service.

A last layer of tape may be applied to a double seal window. The tape is typically a ‘scotch’ or metal type tape. In some embodiments of the present invention, this last layer of tape may be used as a gas or water vapor barrier. In other embodiments of the present invention, this last layer of tape may also be used as a layer of physical protection to workers handling sometimes heavy glass-faced units with sharp cut edges.

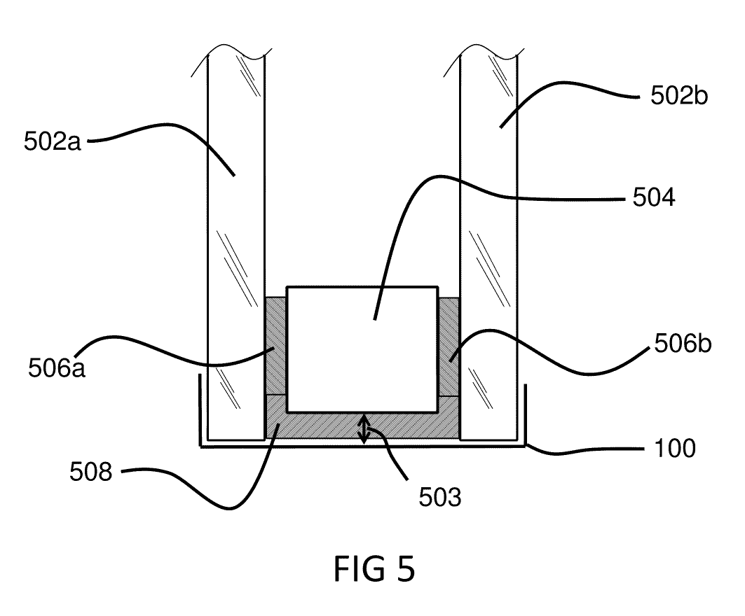

FIG. 5 shows a cross section view of an insulated glass unit according to some embodiments of the present invention. As shown in the figure, the assembly contains two opposing panes of glass 502, separated by a spacer 504 at their perimeter, the spacer 504 being located in from the glass edges 502a and 502b so as to leave a space 503 between these edges. The spacer 504 may be made of any number of materials including common or novel materials or designs, including but not limited to metal, plastic, fiberglass, aerogel, or some other combination. During the assembly, a layer of polyurethane adhesive 506a and 506b is applied to each of the opposing sides of the spacer 504 where the spacer 504 would otherwise contact the glass panes 502a and 502b. Some embodiments of the present invention may include adhesive layers 506a and 506b made of silicon adhesive. Following the assembly of the glass panes 502, the spacer 504 and the adhesive layers 506a and 506b, a second layer of polyurethane adhesive 508 is applied in the gap 503 remaining between the opposing panes of glass 502. Some embodiments of the present invention may include an adhesive layer 508 made of silicon adhesive. Tape 100, according to the embodiment depicted in FIG. 1 of the present invention is applied about the outermost surface of the assembly. It is important to note that in some embodiments of the present invention, tape 100 is wide enough to cover not only all of the polyurethane 508, but also the edge and portions of the outside surface of each of the ends 502a and 502b of each of the opposing glass panes 502. This is required to ensure a quality gas and water vapor barrier. If the insulated glass unit is to be filled with an inert gas, a hole may be drilled through seal 508 and spacer 504 to allow for a gas nozzle. The drilling, gas fill, and plugging should occur before tape 100 is applied.

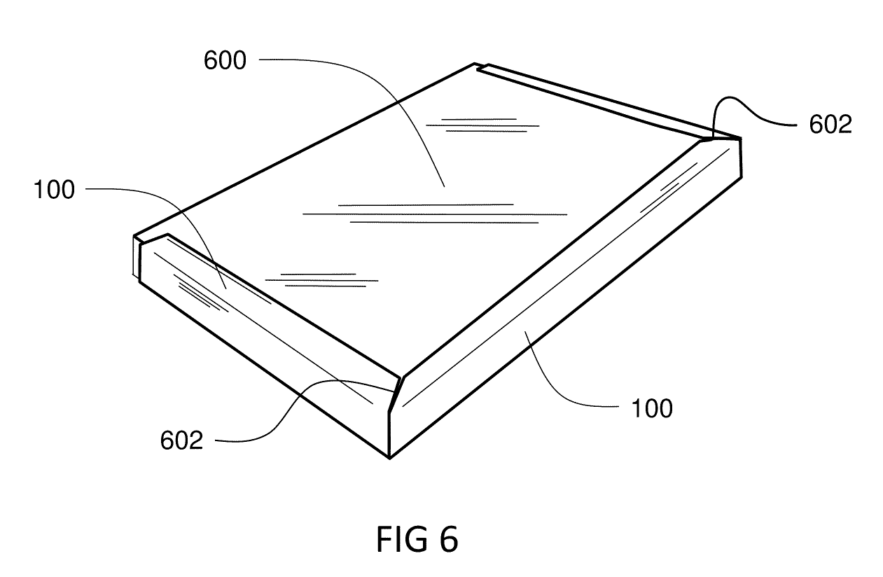

FIG. 6 shows a perspective view of an insulated glass unit 600 constructed in a manner as described in FIG. 5. In this figure, the novel tape 100 is wrapped around the perimeter of insulated glass unit 600 as a continuous strip with tape overlapping and creating a continuous seal at the corners 602.

The dimensions given for each material in the structures and assemblies of this invention can be varied as desired to control cost, overall thickness, weight, anticipated water vapor and thermal control requirements. The described embodiments and their dimensions are illustrative only and not limiting.

Other embodiments of this invention will be obvious in view of the above description.

What is claimed is:

1. A structure for providing a seal between two substantially parallel panes of glass, said structure comprising:
a spacer with two sides adjacent to the inner surfaces of said two panes of glass and a third side facing away from the inner space between said two panes of glass;
a layer of adhesive on each of said two sides of said spacer;
an additional layer of adhesive having a first thickness to attach to and cover said third side; and
a layer of tape placed in contact with the two panes of glass and the additional layer of polyurethane; said layer of tape comprising one or more layers of PVDC.

2. The structure as in claim 1 wherein the adhesive forming the layer of adhesive on each of said two sides of said spacer and the adhesive forming the additional layer of adhesive is formed from a material selected from the group consisting of polyurethane adhesive and silicon adhesive.

3. The structure as in claim 1 wherein said spacer is placed between two panes of glass, each pane of glass having at least three sides forming an edge, with the third side of the spacer being inward from the at least three sides forming an edge of said two panes of glass by approximately said first thickness of the additional layer of adhesive.

4. The structure as in claim 3 wherein the additional layer of adhesive is formed from a material selected from the group consisting of polyurethane adhesive and silicon adhesive.

5. The structure as in claim 3 wherein said additional layer of adhesive is placed on said third side of said spacer in the space between the inner surfaces of the sides forming an edge of said two panes of glass.

6. The structure as in claim 5 wherein said additional layer of adhesive is formed from a material selected from the group consisting of polyurethane adhesive and silicon adhesive.

7. The structure as in claim 1 wherein the layer of tape placed in contact with the two panes of glass and the additional layer of polyurethane further comprises a layer of PIB-based butyl rubber adhesive.

8. The structure as in claim 7 wherein said layer of tape extends up portions of the outer surfaces of said two panes of glass.

9. The structure as in claim 7 further wherein said layer of tape has a thickness between 0.01 and 0.150 inches.

10. A tape for use in a structure for providing a seal between at least two substantially parallel panes of glass, comprising:
at least one layer of PVDC; and
at least one layer of PIB-based butyl rubber adhesive.

11. A method for fabricating a tape for use in a structure for providing a seal between at least two substantially parallel panes of glass, comprising:
having a first layer of PVDC material; and
placing at least one layer of PIB-based butyl rubber adhesive adjacent to the first layer of PVDC material.

12. The method of claim 11 wherein the first layer of PVDC material is fabricated by the steps of:
a. combining vinilydene chloride, vinyl chloride, and alkyl acrylates in a closed system; and
b. adding an initiator to the combination, so as to start the polymerization process.
